(19) United States
(12) Patent Application Publication
(10) Pub. No.: US 2023/0136338 A1
(43) Pub. Date: May 4, 2023

(54) MULTI-DCI BASED PHYSICAL UPLINK SHARED CHANNEL (PUSCH) WITH REPETITION

(71) Applicant: QUALCOMM Incorporated, San Diego, CA (US)

(72) Inventors: Mostafa KHOSHNEVISAN, San Diego, CA (US); Xiaoxia ZHANG, San Diego, CA (US); Jing SUN, San Diego, CA (US); Tao LUO, San Diego, CA (US)

(21) Appl. No.: 17/514,152

(22) Filed: Oct. 29, 2021

(51) Int. Cl. H04W 72/12; H04L 12/24; H04W 72/14; H04L 5/00; H04L 1/08

(52) U.S. Cl. CPC H04W 72/1278; H04L 41/0803; H04W 72/14; H04L 5/0048; H04L 1/08

(57) ABSTRACT

Certain aspects of the present disclosure provide techniques for determining which of two or more invalid symbol patterns to apply to at least one physical uplink shared channels (PUSCHs) with repetition, such as in a multi-transmit-receive-point (multi-TRP) situation where two or more invalid symbol patterns may be used to schedule respective PUSCHs. For example, a pattern may indicate one or more invalid symbols for PUSCH repetition Type B transmission. In a multi-TRP case, each TRP may have a separate pattern indicating different unavailable symbols. One invalid symbol pattern may not be enough for PUSCH transmissions to multi-TRPs. The present disclosure provides techniques for determining and applying one or more of at least two patterns to PUSCH transmissions with repetition.

### BACKGROUND

### Field

Aspects of the present disclosure relate to wireless communications, and more particularly, to techniques for sending uplink transmissions with repetition.

### Description of Related Art

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These and other multiple access technologies have been adopted in various telecommunication standards to provide a common protocol that enables different wireless devices to communicate on a municipal, national, regional, and even global level. However, as the demand for mobile broadband access continues to increase, there exists a need for further improvements in these and emerging wireless communications technologies.

### SUMMARY

Certain aspects of the present disclosure can be implemented in a method for wireless communication by a user equipment (UE). The method generally includes receiving signaling configuring the UE with at least two patterns, each of the at least two patterns indicating one or more symbols considered invalid for physical uplink shared channel (PUSCH) repetition transmission. The method includes receiving signaling scheduling the UE to transmit a first PUSCH with repetition and at least a second PUSCH. The method includes determining which of the at least two patterns to apply when transmitting the first and second PUSCH. The method includes transmitting the first PUSCH and second PUSCH in accordance with the determination.

Certain aspects of the present disclosure can be implemented in an apparatus for wireless communication by a UE. The apparatus generally includes a memory and at least one processor coupled to the memory, the memory and the at least one processor being configured to receive signaling configuring the UE with at least two patterns, each of the at least two patterns indicating one or more symbols considered invalid for PUSCH repetition transmission; receive signaling scheduling the UE to transmit a first PUSCH with repetition and at least a second PUSCH; determine which of the at least two patterns to apply when transmitting the first and second PUSCH; and transmit the first PUSCH and second PUSCH in accordance with the determination.

Certain aspects of the present disclosure can be implemented in an apparatus for wireless communication by a UE. The apparatus generally includes means for receiving signaling configuring the UE with at least two patterns, each of the at least two patterns indicating one or more symbols considered invalid for PUSCH repetition transmission; means for receiving signaling scheduling the UE to transmit a first PUSCH with repetition and at least a second PUSCH; means for determining which of the at least two patterns to apply when transmitting the first and second PUSCH; and means for transmitting the first PUSCH and second PUSCH in accordance with the determination.

Certain aspects of the present disclosure can be implemented in a non-transitory computer readable medium having instructions stored thereon for receiving signaling configuring the UE with at least two patterns, each of the at least two patterns indicating one or more symbols considered invalid for PUSCH repetition transmission; receiving signaling scheduling the UE to transmit a first PUSCH with repetition and at least a second PUSCH; determining which of the at least two patterns to apply when transmitting the first and second PUSCH; and transmitting the first PUSCH and second PUSCH in accordance with the determination.

Certain aspects of the present disclosure can be implemented in a method for wireless communication by at least two network entities (e.g., multiple transmit-receive points (multi-TRPs)). The method generally includes transmitting signaling configuring a UE with at least two patterns, each of the at least two patterns indicating one or more symbols considered invalid for PUSCH repetition transmission. The method includes transmitting signaling scheduling the UE to transmit a first PUSCH with repetition and at least a second PUSCH. The method includes determining which of the at least two patterns to apply when receiving the first and second PUSCH. The method includes receiving the first PUSCH and second PUSCH in accordance with the determination.

Certain aspects of the present disclosure can be implemented in an apparatus for wireless communication by at least two network entities (e.g., multi-TRPs). The apparatus generally includes a memory and at least one processor coupled to the memory, the memory and the at least one processor being configured to transmit signaling configuring a UE with at least two patterns. Each of the at least two patterns indicates one or more symbols considered invalid for PUSCH repetition transmission. The memory and the at least one processor are configured to transmit signaling scheduling the UE to transmit a first PUSCH with repetition and at least a second PUSCH; determine which of the at least two patterns to apply when receiving the first and second PUSCH; and receive the first PUSCH and second PUSCH in accordance with the determination.

Certain aspects of the present disclosure can be implemented in an apparatus for wireless communication by at least two network entities (e.g., multi-TRPs). The apparatus generally includes means for transmitting signaling configuring a UE with at least two patterns, each of the at least two patterns indicating one or more symbols considered invalid for PUSCH repetition transmission; means for transmitting signaling scheduling the UE to transmit a first PUSCH with repetition and at least a second PUSCH; means for determining which of the at least two patterns to apply when receiving the first and second PUSCH; and means for receiving the first PUSCH and second PUSCH in accordance with the determination.

Certain aspects of the present disclosure can be implemented in a computer readable medium having instructions stored thereon for transmitting signaling configuring a UE with at least two patterns, each of the at least two patterns indicating one or more symbols considered invalid for PUSCH repetition transmission; transmitting signaling scheduling the UE to transmit a first PUSCH with repetition and at least a second PUSCH; determining which of the at least two patterns to apply when receiving the first and second PUSCH; and receiving the first PUSCH and second PUSCH in accordance with the determination.

The following description and the appended drawings set forth in detail certain illustrative features of the one or more aspects. These features are indicative, however, of but a few of the various ways in which the principles of various aspects may be employed.

### BRIEF DESCRIPTION OF THE FIGURES

The appended figures depict certain features of the various aspects described herein and are not to be considered limiting of the scope of this disclosure.

FIG. 1 is a block diagram conceptually illustrating an example wireless communication network, in accordance with certain aspects of the present disclosure.

FIG. 2 is a block diagram conceptually illustrating aspects of an example a base station (BS) and user equipment (UE), in accordance with certain aspects of the present disclosure.

FIGS. 3A-3D depict various example aspects of data structures for a wireless communication network.

FIGS. 4A-4B are example timelines illustrating different uplink repetition types, respectively.

FIG. 5 illustrates example timelines of different scenarios of uplink repetitions.

FIG. 6 illustrates an example application of an invalid symbol pattern to a PUSCH repetition.

FIGS. 7A and 7B illustrate multiple downlink control information (DCI) based physical uplink shared channel (PUSCH) scheduling for multiple transmit-receive-points (multi-TRPs) and respective configurations.

FIG. 8 is a flow diagram illustrating example operations for wireless communication by a user equipment (UE), in accordance with certain aspects of the present disclosure.

FIG. 9 is a flow diagram illustrating example operations for wireless communication by network entity (e.g., a base station (BS)), in accordance with certain aspects of the present disclosure.

FIG. 10 is an example call flow diagram illustrating example uplink transmissions with repetition, in accordance with certain aspects of the present disclosure.

FIG. 11 is an example application of one of at least two invalid symbol patterns to a PUSCH repetition, in accordance with certain aspects of the present disclosure.

FIG. 12 is an example application of two invalid symbol patterns to a PUSCH repetition, in accordance with certain aspects of the present disclosure.

FIG. 13 illustrates an example wireless communications device configured to perform operations for the methods disclosed herein, in accordance with certain aspects of the present disclosure.

FIG. 14 illustrates an example wireless communications device configured to perform operations for the methods disclosed herein, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide systems and methods for determining which of two or more invalid symbol patterns to apply to at least one physical uplink shared channels (PUSCHs) with repetition, such as in a multi-transmit-receive-point (multi-TRP) situation where two or more invalid symbol patterns may be used to schedule respective PUSCHs. Invalid symbol patterns generally indicate one or more invalid symbols for PUSCH repetition Type B transmission. In a multi-TRP case, each TRP may have a separate pattern indicating different unavailable symbols. As such, one invalid symbol pattern may not be enough for PUSCH transmissions to multi-TRPs. The present disclosure provides techniques for determining which, of at least two patterns, to apply for PUSCH transmissions with repetition.

For example, a user equipment (UE) may receive signaling that configures the UE with at least two patterns. Each of the at least two patterns may indicate one or more symbols considered invalid for PUSCH repetition transmission. The UE may receive signaling scheduling the UE to transmit a first PUSCH with repetition and at least a second PUSCH. For example, in a multi-TRP situation, a first downlink control information (DCI) may schedule a first PUSCH to be transmitted to a first TRP, and a second DCI may schedule a second PUSCH to be transmitted to a second TRP. The UE determines which of the at least two patterns to apply when transmitting the first and the second PUSCH, such as one, all, or none of the at least two patterns. The UE transmits the first PUSCH and the second PUSCH in accordance with the determination.

When transmitting two PUSCHs to respective TRPs in a common component carrier (CC), and when the two PUSCHs are at least partially overlapping in time, conventional methods (often limited to one symbol pattern) may be insufficient in handling different symbol availabilities in multiple TRPs. Because the invalid/unavailable symbols may be different for each TRP, segmentations of nominal PUSCH repetitions may also be different. However, in the cases when two or more invalid symbol patterns (e.g., of different TRPs) are provided to the UE, the UE may still need to determine which of the two or more invalid symbol patterns to apply. The present disclosure provides methods and techniques for determining and applying two or more invalid symbol patterns for corresponding two or more TRPs to at least one PUSCH transmission with repetition, such that under specific conditions, the UE may apply one, all, or none of the two or more invalid symbol patterns.

### Brief Introduction to Wireless Communication Networks

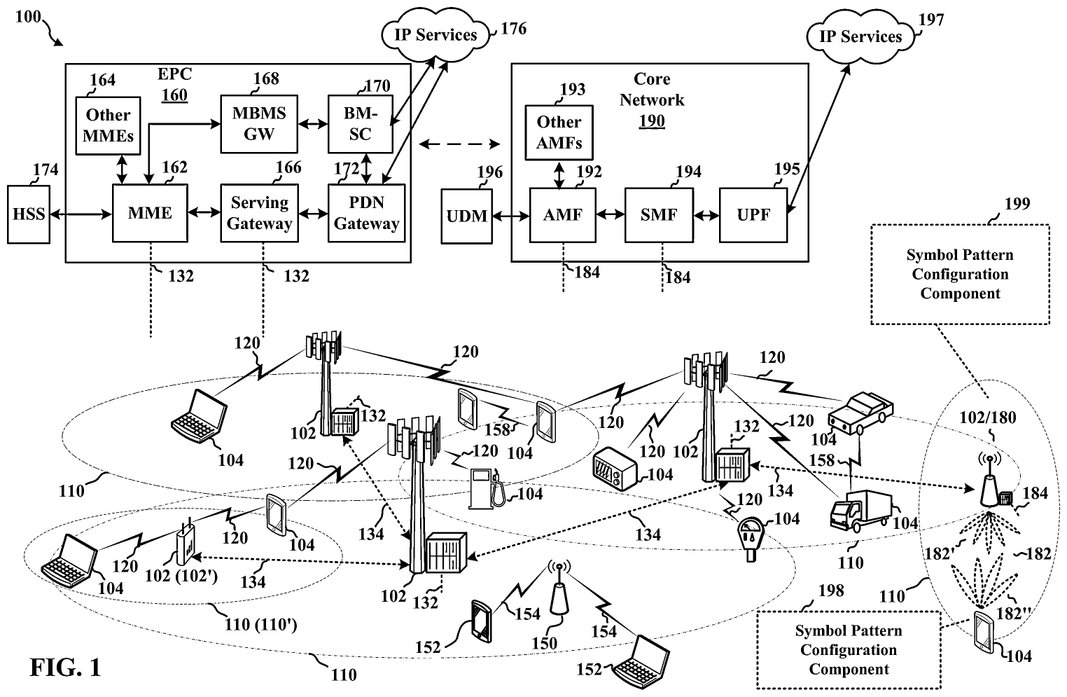

FIG. 1 depicts an example of a wireless communications system 100, in which aspects described herein may be implemented. While FIG. 1 is briefly introduced here for context, additional aspects of FIG. 1 are described below.

Generally, wireless communications system 100 includes base stations (BSs) 102, user equipments (UEs) 104, an Evolved Packet Core (EPC) 160, and core network 190 (e.g., a 5G Core (5GC)), which interoperate to provide wireless communications services.

Base stations 102 may generally provide an access point to the EPC 160 and/or core network 190 for a UE 104, and may generally perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, delivery of warning messages, among other functions, including those further described herein. Base stations described herein may include and/or be referred to as a gNB, Node B, eNB, an access point, a base transceiver station, a radio base station, a radio transceiver, or a transceiver function, or a transmit reception point (TRP) in various contexts.

Base stations 102 wirelessly communicate with UEs 104 via communications links 120. Each of base stations 102 may generally provide communication coverage for a respective geographic coverage area 110, which may overlap in some cases. For example, small cell 102′ (e.g., a low-power base station) may have a coverage area 110′ that overlaps the coverage area 110 of one or more macrocells (e.g., high-power base stations).

The communication links 120 between base stations 102 and UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity in various aspects.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device (e.g., a smart watch, smart ring, smart bracelet, etc.), a vehicle, an electric meter, a gas pump, a large or small kitchen appliance, a healthcare device, an implant, a sensor/actuator, a display, or any other similar functioning device. Some of UEs 104 may be internet of things (IoT) devices (e.g., parking meter, gas pump, toaster, vehicles, heart monitor, etc.), always on (AON) devices, or edge processing devices. UEs 104 may also be referred to more generally as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, or a client.

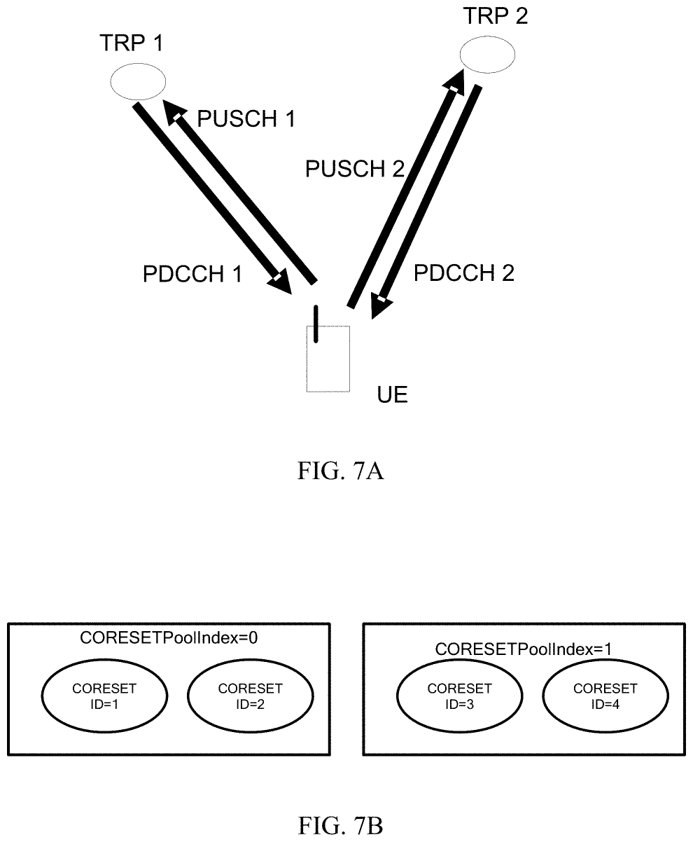

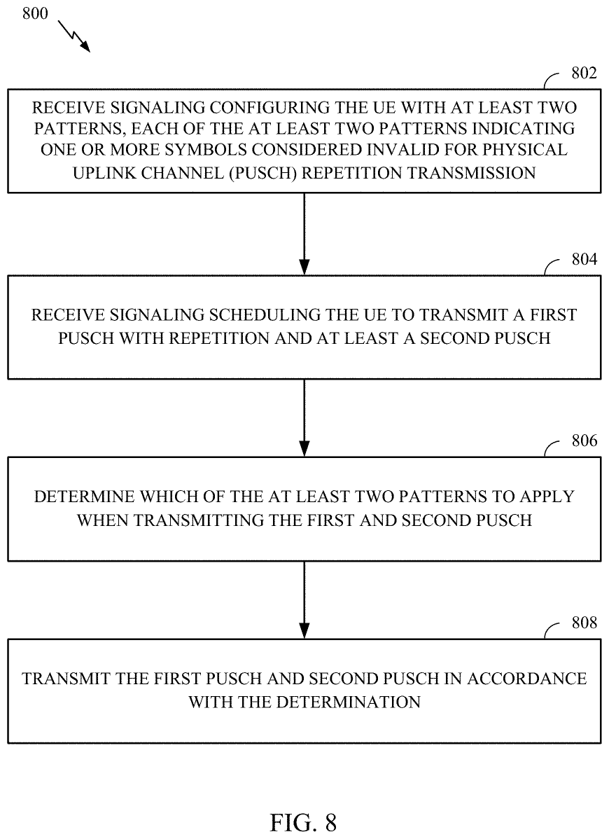

In some cases, a base station 102 in the wireless communication network 100 may include a symbol pattern configuration component 199, which may be configured to perform the operations shown in FIG. 8, as well as other operations described herein for determining which patterns to apply in PUSCH with repetitions. Additionally, a UE 104 in the wireless communication network 100 may include a symbol pattern configuration component 198, which may be configured to perform the operations depicted and described with respect to FIG. 7, as well as other operations described herein for determining which patterns to apply in PUSCH with repetitions.

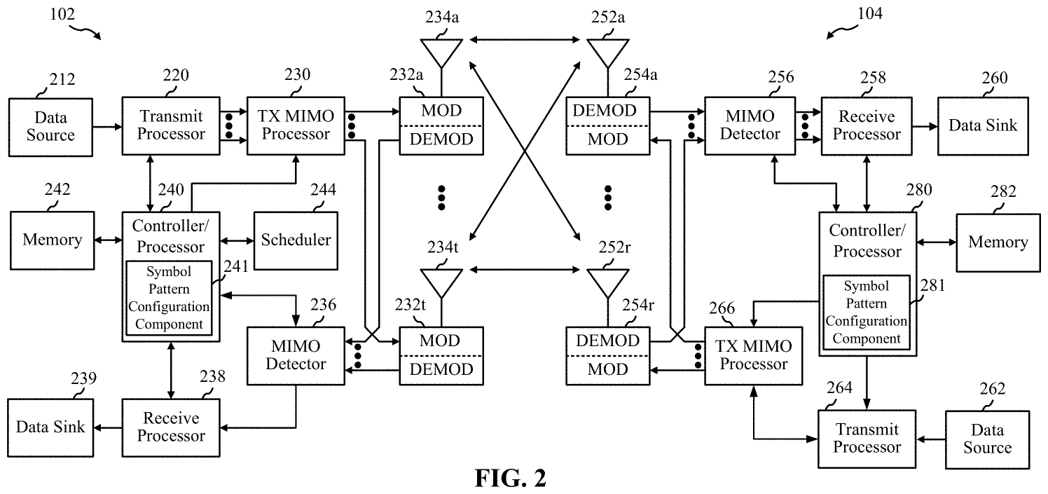

FIG. 2 depicts certain example aspects of a base station (BS) 102 and a user equipment (UE) 104. As with FIG. 1, FIG. 2 is briefly introduced here for context and additional aspects of FIG. 2 are described below.

Generally, BS 102 includes various processors (e.g., 220, 230, 238, and 240), antennas 234a-t, transceivers 232a-t, and other aspects, in order to transmit data (e.g., source data 212) and to receive data (e.g., data sink 239). For example, BS 102 may send and receive data between itself and UE 104.

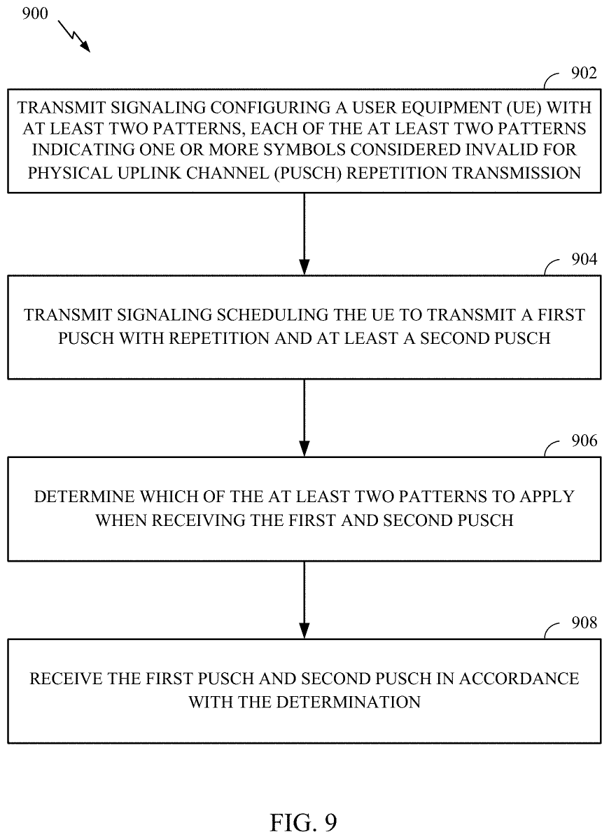

In the depicted example, BS 102 includes controller/processor 240, which comprises a symbol pattern configuration component 241. In some cases, the symbol pattern configuration component 241 may be configured to implement symbol pattern configuration component 199 of FIG. 1 and to perform the operations depicted and described with respect to FIG. 9.

UE 104 generally includes various processors (e.g., 258, 264, 266, and 280), antennas 252a-r, transceivers 254a-r, and other aspects, in order to transmit data (e.g., source data 262) and to receive data (e.g., data sink 260).

In the depicted example, UE 104 includes controller/processor 280, which comprises a symbol pattern configuration component 281. In some cases, the symbol pattern configuration component 281 may be configured to implement the symbol pattern configuration component 198 of FIG. 1 and to perform the operations depicted and described with respect to FIG. 8.

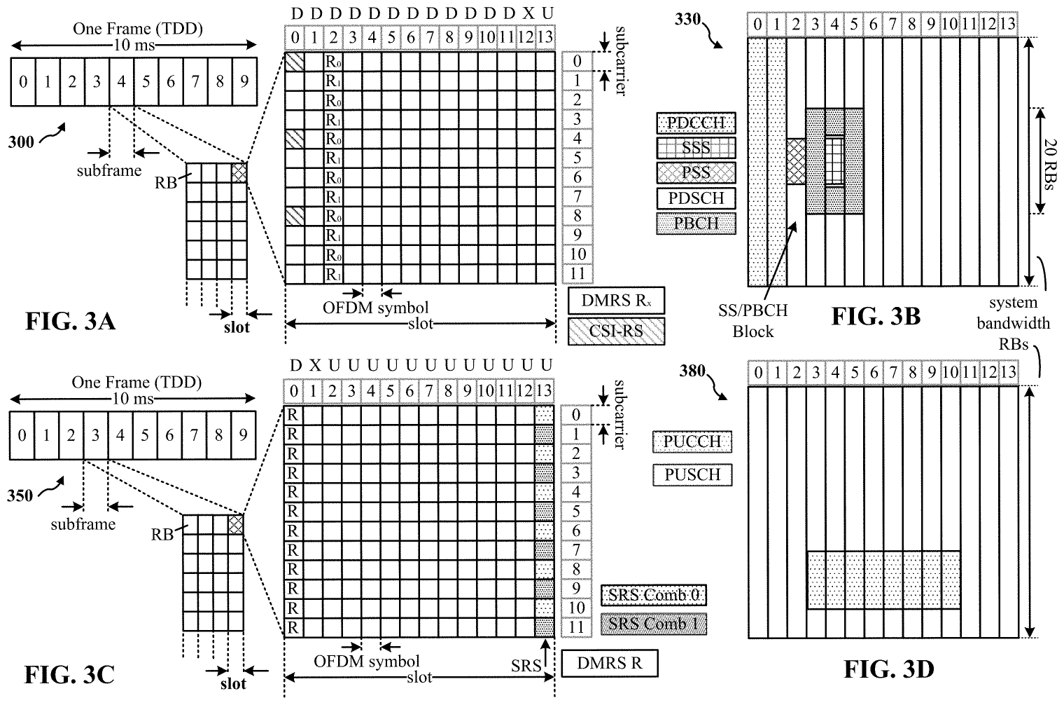

FIGS. 3A-3D depict various example aspects of data structures for a wireless communication network, such as wireless communication network 100 of FIG. 1. In particular, FIG. 3A is a diagram 300 illustrating an example of a first subframe within a 5G (e.g., 5G NR) frame structure. FIG. 3B is a diagram 330 illustrating an example of DL channels within a 5G subframe. FIG. 3C is a diagram 350 illustrating an example of a second subframe within a 5G frame structure. FIG. 3D is a diagram 380 illustrating an example of UL channels within a 5G subframe.

### Brief Introduction to mmWave Wireless Communications

The electromagnetic spectrum is often subdivided, based on frequency/wavelength, into various classes, bands, channels, etc. In various aspects, a frequency may also be referred to as a carrier, a subcarrier, a frequency channel, a tone, or a subband.

In 5G, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “Sub-6 GHz” band in various documents and articles. A similar nomenclature issue sometimes occurs with regard to FR2, which is sometimes referred to (interchangeably) as a “millimeter wave” band in documents and articles, despite being different from the extremely high frequency (EHF) band (30 GHz-300 GHz), which is identified by the International Telecommunications Union (ITU) as a “millimeter wave” band because wavelengths at these frequencies are between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

Communications using the mmW/near mmW radio frequency band (e.g., 3 GHz-300 GHz) may have higher path loss and a shorter range compared to lower frequency communications. Accordingly, in FIG. 1, mmW base station 180 may utilize beamforming 182 with the UE 104 to improve path loss and range. To do so, base station 180 and the UE 104 may each include a plurality of antennas, such as antenna elements, antenna panels, and/or antenna arrays to facilitate the beamforming.

In some cases, base station 180 may transmit a beamformed signal to UE 104 in one or more transmit directions 182′. UE 104 may receive the beamformed signal from the base station 180 in one or more receive directions 182″. UE 104 may also transmit a beamformed signal to the base station 180 in one or more transmit directions 182″. Base station 180 may receive the beamformed signal from UE 104 in one or more receive directions 182′. Base station 180 and UE 104 may then perform beam training to determine the best receive and transmit directions for each of base station 180 and UE 104. Notably, the transmit and receive directions for base station 180 may or may not be the same. Similarly, the transmit and receive directions for UE 104 may or may not be the same.

### Example Mechanisms for Applying Invalid Symbol Patterns in Uplink Repetitions

As noted above, 5G New Radio (NR) networks define different types of uplink (UL) repetition mechanisms (type A and type B) for physical UL shared channel (PUSCH) and/or a physical UL control channel (PUCCH) transmissions. Repetition may increase the likelihood of successful reception, for example, allowing for increased coding gain and soft combining at the network side.

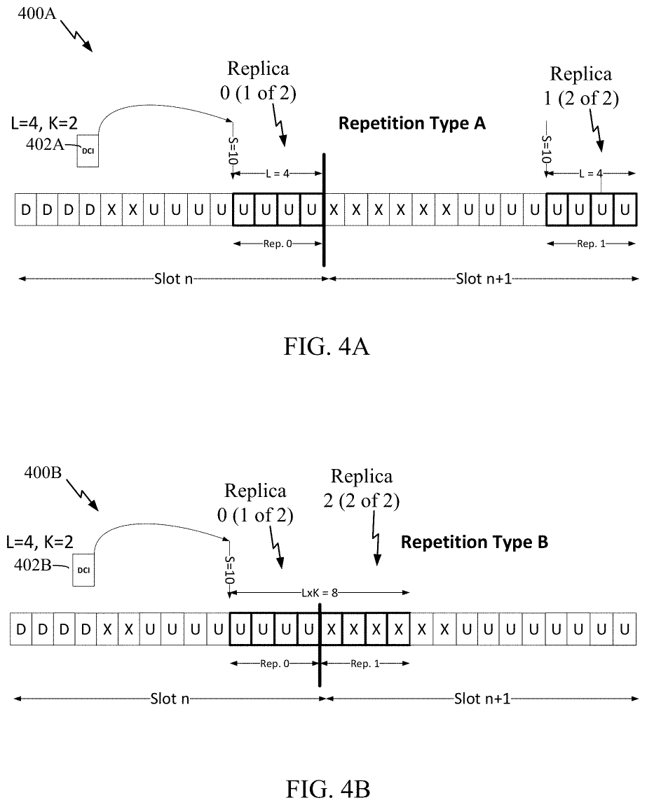

As illustrated in the timeline 400A of FIG. 4A, which illustrates an example scenario of repetition type A, a repetition pattern may be based on information (number K, length L, and starting symbol S) contained in a Start Length Information Value (SLIV) indicated via a DCI.

In the case of Type A, one PUSCH is transmitted in each slot and the time domain resource allocation (TDRA) is the same in each slot. Thus, as illustrated in FIG. 4A, repetitions repeat across slots, occupying the same resources in each slot. In the illustrated example, the repetition parameters (S, L, and K) may be configured in downlink control information (DCI) 402A conveying a SLIV. In the illustrated example, there are two repetitions (K=2) with a 4 symbol length (L=4). A first UL repetition 0 occurs in slot n, starting at a 10^{th} symbol (e.g., S=10), while the second repetition 1 occurs in slot n+1.

As illustrated in the timeline 400B of FIG. 4B, type B repetitions may be sent back-to-back within and/or across slots in accordance with the information in the configured SLIV (which may be a new format) conveyed the DCI 402B. For type B repetition, a TDRA field in the DCI may indicate the resource for a first “nominal” repetition. The time domain resources for the remaining repetitions may be derived based at least on the resources for the first repetition and UL/DL direction of symbols. The SLIV in the DCI indicates a “nominal” number of repetitions. The repetitions and number of repetitions are referred to as nominal because the scheduled repetitions may be considered theoretical in comparison to what is actually achievable (actual repetitions) based on actual uplink/downlink (UL/DL) direction of symbols in the relevant slot(s).

As shown, the nominal repetition may be consecutive (e.g., Replica 0 and Replica 2). The nominal repetitions may have the same length. When a nominal repetition crosses the slot boundary, the repetition may be divided into two actual repetitions (e.g., Rep. 0 and Rep. 1).

Further, in the illustrated example, the configured starting symbol of 10 (S=10), number of repetitions (K=2), and length of each repetition (L=4) results in the first repetition (Rep. 0) occupying the last 4 symbols in slot n and the second repetition (Rep. 1) occupying the first four symbols of slot n+1). Thus, as illustrated, the repetitions cross the slot boundary. Type B repetition may provide enhanced flexibility, for example, allowing for a dynamic indication of a number of repetitions, inter-nominal PUSCH frequency hopping, and new UL/downlink (DL) symbol interaction (e.g., opportunistically allowing flexible symbols to be used for uplink repetition).

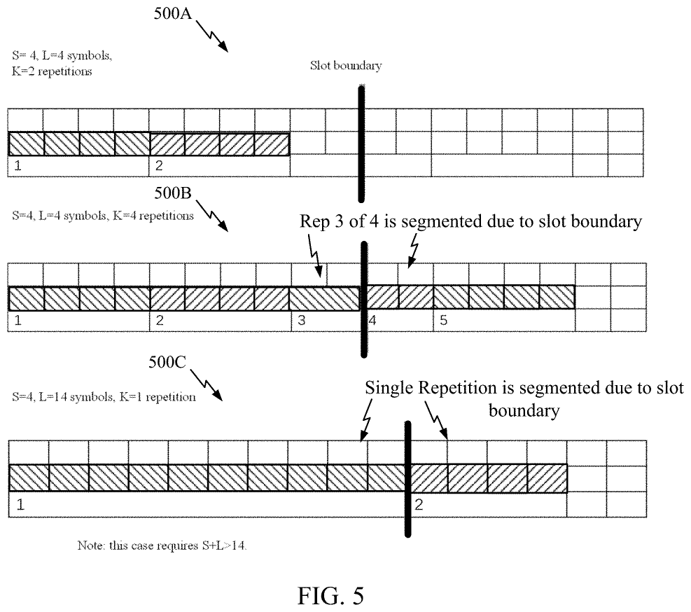

FIG. 5 illustrates additional example timelines of type B slot repetitions. As shown in the first timeline 500A, with a starting symbol of 4 (S=4), 2 repetitions (K=2) of length 4 (L=4), both repetitions may be contained in the same slot (the repetitions do not cross the slot boundary).

As illustrated in timeline 500B, if the number of repetitions is increased to 4 (K=4), the third repetition of length 4 would cross the slot boundary. In such cases, this nominal repetition may be segmented, as shown, into two smaller actual repetitions of length 2. Similarly, as illustrated in timeline 500C, even if the number of repetitions is only 1 (K=1) but the length is increased to 14 (L=14), the single repetition of length 14 would cross the slot boundary. In such cases, this nominal repetition may be segmented, as shown, into two smaller actual repetitions of lengths 10 and 4.

Segmentation may also occur due to the occurrence of semi-static DL symbols, and/or in response to a parameter InvalidSymbolPattern (indicating the occurrence of a symbol not valid for a nominal uplink repetition). For example, an invalid symbol pattern (or referred to generally as a pattern) identifies unavailable or invalid symbols in a PUSCH with repetition. For example, when some of the symbols of a nominal repetition are identified as invalid symbols, a nominal repetition is divided into multiple actual repetitions after removing the invalid symbols. Invalid symbols can be produced or generated based on: one or more indicated symbols in a pattern (e.g., by definition or indication); semi-static downlink symbols; synchronization signal block (SSB) symbol(s), or where CORESET0 (for Type0-PDCCH) is monitored. If an actual repetition after segmentation has only one symbol, the one symbol may be omitted.

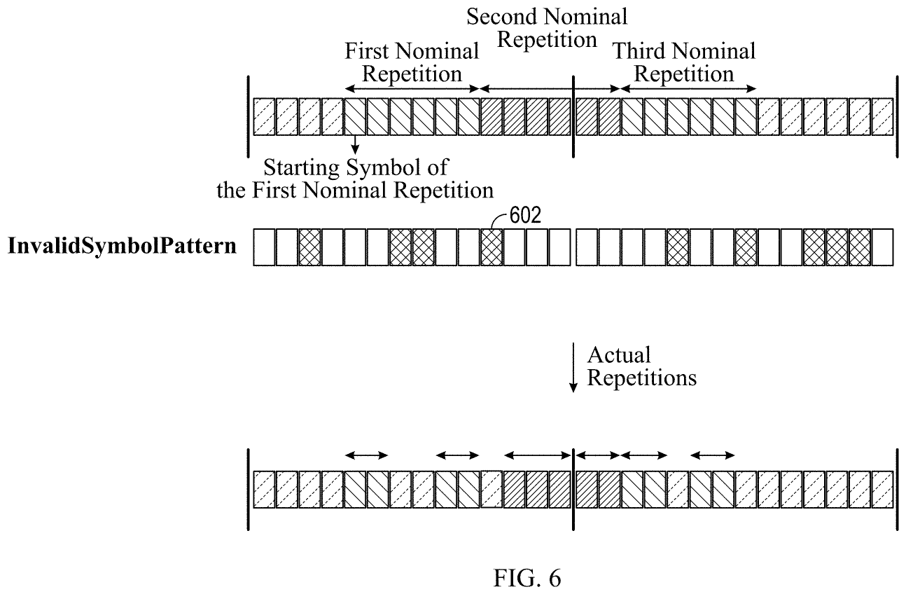

FIG. 6 illustrates an example application of an invalid symbol pattern to a PUSCH repetition. The invalid symbol pattern may be configured by the UE with a higher layer parameter (e.g., InvalidSymbolPattern or invalidSymbolPattern). For example, the pattern provides a symbol level bitmap spanning one or two slots: Bitmap of length 14 (one slot) or 28 (2 slots). A two-slot pattern is shown in FIG. 6. In some cases, a bit value equal to 1 in the symbol level bitmap symbols indicates that the corresponding symbol is an invalid symbol 602 for PUSCH repetition (e.g., Type B transmission).

In addition, the UE may be configured with a time-domain pattern (e.g., with a higher layer parameter periodicityAndPattern inside invalidSymbolPattern) to further configure the pattern. The periodicity of the time-domain pattern may be {1, 2, 4, 5, 8, 10, 20 or 40} units long. Each bit in periodicityAndPattern is one unit (1 or 2 slots). For example, a bit value equal to 1 indicates that the symbol level bitmap symbols is present in the unit. When the time-domain pattern is not configured, the UE may assume that the symbol level bitmap symbols is always present in each unit.

In some cases, when the parameter invalidSymbolPattern is configured, the UE may apply the invalid symbol pattern (e.g., a single pattern) based on certain conditions, such as whether the PUSCH is scheduled by DCI format 0_1 or 0_2.

If the PUSCH is scheduled by DCI format 0_1, or corresponds to a Type 2 configured grant (CG) activated by DCI format 0_1, and if a related parameter (e.g., invalidSymbolPatternIndicatorDCI-0-1) is configured, then when the invalid symbol pattern indicator field is set as 1, the UE then applies the invalid symbol pattern. Otherwise, the UE does not apply the invalid symbol pattern.

If the PUSCH is scheduled by DCI format 0_2, or corresponds to a Type 2 CG activated by DCI format 0_2, and if a related parameter (e.g., invalidSymbolPatternIndicatorDCI-0-2) is configured, then when the invalid symbol pattern indicator field is set as 1, the UE applies the invalid symbol pattern. Otherwise, the UE does not apply the invalid symbol pattern.

Otherwise, if neither of these conditions (e.g., scheduled by DCI format 0_1 or 0_2) are met, then the UE applies the invalid symbol pattern. For example, the UE may apply the invalid symbol pattern for scheduled dynamic grant (DG) or activated Type 2 CG, or for Type 1 CG-PUSCH when such PUSCH is scheduled by a DCI without an invalid symbol indicator field.

This technique of applying one invalid symbol pattern, however, may not apply to situations where two or more invalid symbol patterns are provided to the UE for multi-TRP PUSCH transmissions. The present disclosure provides techniques for determining which of two or more patterns to apply when transmitting multiple PUSCHs.

FIGS. 7A and 7B illustrate multiple DCI based PUSCH scheduling for multi-TRPs and respective configurations. As shown in FIG. 7A, for multi-TRP transmission, each of multiple PUSCHs (to be transmitted to one of the multiple TRPs) may be scheduled by a DCI. For example, each TRP may transmit a DCI to the UE via a PDCCH. For example, PDCCH1 (transmitted from TRP1) may carry a first DCI that schedules PUSCH1 to be transmitted to TRP1. Similarly, PDCCH2 (transmitted from TRP2) may carry a second DCI that schedules PUSCH2 to be transmitted to TRP2.

For monitoring the DCIs transmitted from different TRPs, a number of different control resource sets (CORESETs) may be used. As used herein, the term CORESET generally refers to a set of physical resources (e.g., a specific area on the NR Downlink Resource Grid) and a set of parameters that is used to carry PDCCH/DCI. For example, a CORESET may by similar in area to an LTE PDCCH area (e.g., the first 1, 2, 3, 4 OFDM symbols in a subframe).

In some cases, TRP differentiation at the UE side may be based on CORESET groups or CORESET pool index. For example, CORESET groups may be defined by higher layer signaling of an index per CORESET which can be used to group the CORESETs. Each CORESET (e.g., up to five CORESETs) may be configured with a value of CORESETPoolIndex. The value of CORESETPoolIndex can be 0 or 1.

As shown in FIG. 7B, for two CORESET groups, two indexes may be used (as shown, CORESETPoolIndex=0 and CORESETPoolIndex=1). Each of the GORESET group may further include at least two CORESET identifiers (e.g., ID=1 and ID=2). Thus, a UE may monitor for transmissions in different CORESET groups and infer that transmissions sent in different CORESET groups come from different TRPs. Otherwise, the notion of different TRPs may be transparent to the UE. In some cases, condition in 3GPP specifications may determine how the UE is configured with multi-DCI based multi-TRP: for example, a UE may be configured by higher layer parameter PDCCH-Config that contains two different values of CORESETPoolIndex in CORESETs for the active BWP of a serving cell. In another example (e.g., Rel. 16), PUSCHs may be time-division multiplexed (TDMed) in a given CC/serving cell (even across TRPs/CORESETPoolIndex values). Both space division multiplexing (SDM) and/or frequency division multiplexing (FDM) may be also applicable.

According to previous specifications (e.g., in Rel. 15, 16, or 17), two PUSCHs in a common CC overlapping in time may not be supported. In Rel. 18, simultaneous PUSCH transmission (e.g., PUSCH1+PUSCH2) in one CC may be specified. This corresponds to two PUSCHs that are at least partially overlapping in the time domain. As mentioned, multi-DCI framework (with multiple CORESETPoolIndex values) may support scheduling such PUSCHs. However, when one or both of the two PUSCHs are scheduled according to repetition Type B, one invalid symbol pattern may not be enough, because each TRP can have a respective invalid symbol pattern, as the unavailable symbols for each TRP may be different. Invalid symbols, and hence, segmentation of nominal PUSCH repetitions can depend on the TRP (CORESETPoolIndex value) associated with the PUSCH transmission.

Accordingly, certain aspects of the present disclosure provide techniques for determining and applying two or more patterns in multi-DCI based PUSCH transmissions. For example, a UE may receive signaling configuring the UE with at least two patterns and receive signaling scheduling the UE to transmit a first PUSCH repetition and at least a second PUSCH. The UE may determine, according to the present disclosure, which of the at least two patterns to apply when transmitting the first and second PUSCH.

### Example Determination and Application of Invalid Symbol Patterns

FIG. 8 is a flow diagram illustrating example operations 800 for wireless communication, in accordance with certain aspects of the present disclosure. The operations 800 may be performed, for example, by a UE (e.g., such as the UE 104 in the wireless communication network 100) capable of determining which of at least two invalid symbol patterns to apply to multi-TRP PUSCH transmissions. The operations 800 may be implemented as software components that are executed and run on one or more processors (e.g., controller/processor 280 of FIG. 2). Further, the transmission and reception of signals by the UE in operations 800 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

The operations 800 begins, at 802, by receiving signaling configuring the UE with at least two patterns. Each of the at least two patterns indicates one or more symbols considered invalid for PUSCH repetition transmission. For example, each of the at least two patterns may be similar to the invalid symbol pattern 602 shown in FIG. 6. In some cases, the at least two patterns are associated with some corresponding parameters. The parameters may, in some cases, be a CORESET pool index value for CORESET configuration. In another example, the parameters may be an identification of a UE panel or an indication of a UE beam group or an indication of a SRS resource set.

At 804, the UE receives signaling that schedules the UE to transmit a first PUSCH with repetition and at least a second PUSCH. The first PUSCH with repetition may be a PUSCH with repetition Type B. In some cases, the first PUSCH with repetition and the second PUSCH are in common component carriers (CCs) or bandwidth parts (BWPs). The at least second PUSCH at least partially overlaps in time with the first PUSCH with repetition. In some cases, the first PUSCH with repetition and the at least one second PUSCH are scheduled by respective DCIs from different TRPs in a multi-TRP setting.

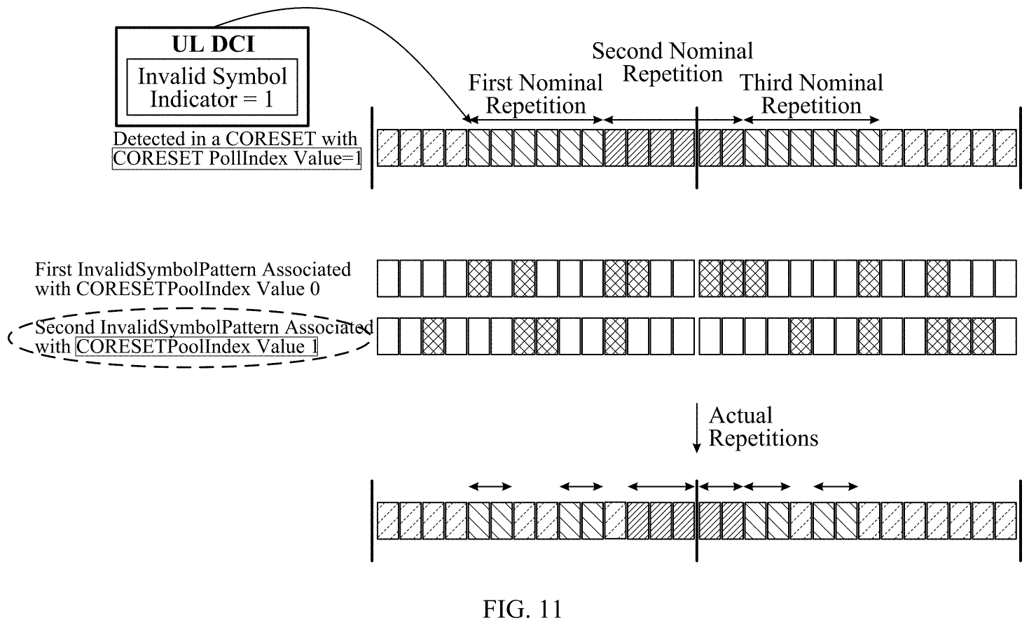

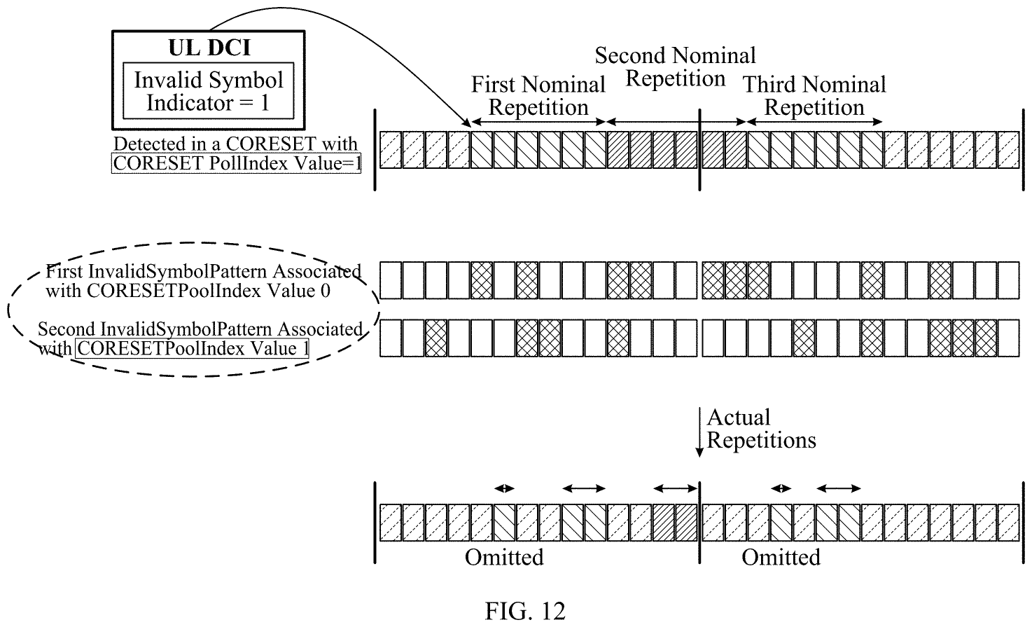

At 806, the UE determines which of the at least two patterns to apply when transmitting the first and second PUSCHs. Depending on different signaling or conditions, the UE may determine to apply one or more, all, or none of the at least two patterns. For example, the determination may be performed by selecting one of the at least two patterns based on a corresponding parameter associated with one of the first PUSCH with repetition dynamically scheduled or activated by the DCI scheduling the first PUSCH with repetition. The determination may also be based on a value in an invalid symbol indicator field in the DCI. The value may indicate any combination or none of the at least two patterns. In some cases, the determination may be performed by selecting one of the at least two patterns based on a corresponding parameter value associated with one of the first PUSCH with repetition of a Type 1 configured grant (CG). Examples of determining which of the at least two patterns to apply are discussed below in relation to FIGS. 11 and 12.

At 808, the UE transmits the first PUSCH and the second PUSCH in accordance with the determination.

In aspects, the UE may determine which of the at least two patterns to apply by selecting one of the at least two patterns based on a corresponding parameter associated with one of the first PUSCH with repetition dynamically scheduled or activated by the DCI. In some cases, the DCI includes an invalid symbol indicator field indicating whether to apply the selected one of the at least two patterns based on the corresponding parameter associated with one of the first PUSCH with repetition. In some cases, the UE determines to apply the one of the at least two patterns when the DCI does not include an invalid symbol indicator field. In some cases, the UE may determine to apply all or none of the at least two patterns when the DCI does not provide a relevant indication.

In aspects, the UE may determine which of the at least two patterns to apply by determining based on a value in an invalid symbol indicator field in the DCI, wherein the value indicates any combination or none of the at least two patterns. In some cases, when the at least two patterns includes two patterns, the value includes a two bit value for indicating: none of the at least two patterns to be applied; a first of the two patterns to be applied; a second of the two patterns to be applied; or both of the two patterns to be applied. In some cases, the UE may always apply a first one of the two patterns associated with a first one of the corresponding parameters corresponding to the DCI. The value includes a one bit value for indicating: whether to apply, based on the one bit value, a second one of the at least two patterns associated with a second one of the corresponding parameters not corresponding to the DCI.

In aspects, the UE receives signaling configuring the UE with at least two patterns by receiving the at least two patterns via radio resource control (RRC) signaling.

In aspects, the UE may select one of the at least two patterns based on a corresponding parameter value associated with one of the first PUSCH with repetition of a Type 1 configured grant (CG). For example, the one of the at least two patterns is associated with the corresponding parameter value configured for the one of the first PUSCH with repetition via radio resource control (RRC) signaling. In some cases, the RRC signaling includes a parameter that, when configured for each CG configuration, explicitly indicates a selection of the at least two patterns; or when not configured for each CG configuration, implicitly indicates a remainder of the at least two patterns.

In some cases, the RRC signaling configures the first PUSCH with repetition, and includes a pattern identification parameter, for each CG configuration, identifying one of the at least two patterns. The UE may determine to apply none of the at least two patterns when the pattern identification parameter does not identify any of the at least two patterns.

FIG. 9 is a flow diagram illustrating example operations 900 for wireless communication by one or more network entities (e.g., base stations, or multi-TRPs) that may be considered complementary to operations 800 of FIG. 8. For example, the operations 900 may be performed by a BS (e.g., such as the BS 102 in the wireless communication network 100) for monitoring for uplink repetitions sent according to a determination of which of at least two patterns applied to a PUSCH with repetition. The operations 900 may be implemented as software components that are executed and run on one or more processors (e.g., controller/processor 240 of FIG. 2). Further, the transmission and reception of signals by the BS in operations 900 may be enabled, for example, by one or more antennas (e.g., antennas 234 of FIG. 2). In certain aspects, the transmission and/or reception of signals by the BS may be implemented via a bus interface of one or more processors (e.g., controller/processor 240) obtaining and/or outputting signals.

The operations 900 begin, at 902, by transmitting signaling configuring a UE with at least two patterns that indicate one or more symbols considered invalid for PUSCH repetition transmission. As noted above, in some cases, the at least two patterns may be associated with corresponding parameters for PUSCH transmissions.

At 904, the network entities transmit signaling scheduling the UE to transmit a first PUSCH with repetition and at least a second PUSCH. As mentioned before, the first PUSCH may at least partially overlap with the second PUSCH in time. In a multi-TRP situation, the first PUSCH is for a first one of the multi-TRPs, while the second PUSCH is for the second one of the multi-TRPs.

At 906, the network entities determine which of the at least two patterns to apply when receiving the first and the second PUSCH. For example, the network entities may receive indications from the UE regarding the UE's determination. In some cases, the network entities may determine which of the at least two patterns should be applied and signal to the UE to apply the network entities' determination.

At 908, the network entities receive the first PUSCH with repetition and the at least second PUSCH in accordance with the determination.

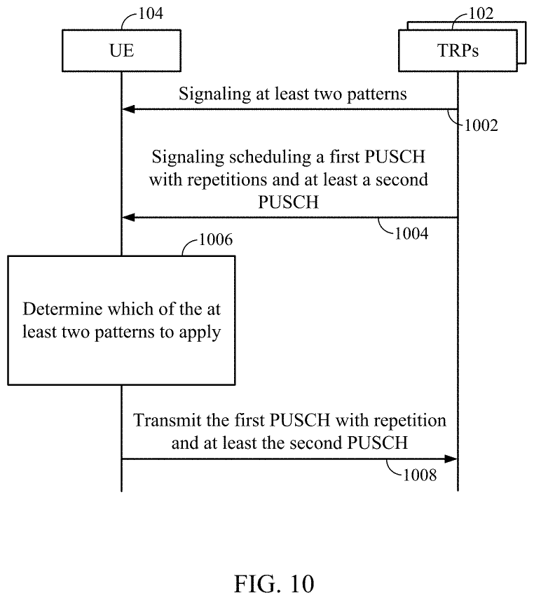

Operations 800 and 900 of FIGS. 8 and 9 may be understood with reference to the example call flow diagram 1000 of FIG. 10, which shows interactions between TRPs 102 and a UE 104 sending uplink repetitions according to a repetition pattern modified to avoid segmentation, in accordance to aspects of the present disclosure.

At 1002, the TRPs 102 transmits signaling that configures the UE 104 with at least two patterns. For ease of explanation, the TRPs 102 include two TRPs and the at least two patterns include two respective invalid symbol patterns for transmission of two PUSCHs from the UE 104 to the TRPs 102. The two PUSCHs may be in a common CC or BWP configured with CORESETs associated with two CORESETPoolIndex values. The two patterns may be RRC-configured with two “InvalidsymbolPattern” associated with the two CORESETPoolIndex values (e.g., corresponding to the two TRPs 102), such as for transmission of PUSCH with repetition Type B. For example, the patterns are used for determination of actual PUSCH repetitions by removing the invalid symbols indicated therein.

At 1004, the TRPs 102 transmits signaling that schedules the UE 104 to transmit a first PUSCH with repetitions and at least a second PUSCH. The first PUSCH and the second PUSCH may be in common CCs or BWPs. The first PUSCH may be scheduled by a DCI, which may include corresponding parameters associated with the at least two patterns. For example, the corresponding parameters may include a CORESET pool index value for CORESET configuration. In some cases, the corresponding parameters may include an indication of a transmission group (e.g., a UE group); a sounding reference signal (SRS) resource set; an identification of UE panel; an indication of a UE beam group, or any combination of these parameters.

At 1006, the UE determines which of the at least two patterns to apply when transmitting the first and the second PUSCH. In one example, depending on the corresponding parameters (e.g., the CORESET pool index value) in association of PUSCH, the UE may determine, by selecting, one of the at least two patterns to apply. In another example, the UE may determine that any combination, none, or all of the at least two patterns may be applied. At 1008, the UE transmits the first and the second PUSCH respectively to the TRPs.

FIG. 11 is an example application of one of at least two invalid symbol patterns to a PUSCH repetition, in accordance with certain aspects of the present disclosure. In this example, only one of the two patterns may be selected and applied to the PUSCH transmission, depending on the association of the PUSCH with a corresponding parameter, such as the CORESETPoolIndex value. After the determination or selection, the UE may or may not actually apply the pattern based on conditions related to scheduling and/or values in an indicator field (e.g., as aforementioned in relation to FIG. 6).

First, each of the at least two patterns may be respectively associated with a corresponding parameter scheduled or activated by DCI signaling, which corresponds to one of the multi-TRPs. For example, in the case when the PUSCH is dynamically scheduled (e.g., for dynamic grant (DG), or activated (for Type 2 configured grant (CG)) by a DCI received in a CORESET associated with a given CORESETPoolIndex value, the pattern associated with the same CORESETPoolIndex value may be selected or considered. As shown in FIG. 11, two patterns are signaled to the UE: a first pattern (i.e., the first InvalidSymbolPattern) associated with a CORESET pool index value of 0; and a second pattern (i.e., the second InvalidSymbolPattern) associated with a CORESET pool index value of 1. The uplink DCI includes an invalid symbol indicator, which has a value of 1. The UE detects the scheduling DCI, in a CORESET associated or configured with a CORESET pool index value of 1. As such, the UE determines that the second pattern should be applied upon determining the CORESET pool index value being 1.

Upon determining/selecting the pattern, if the DCI (e.g., DCI format 0_1 or format 0_2) is configured to include an invalid symbol indicator field (e.g., the invalid symbol indictor in the UL DCI of FIG. 11), then whether to apply the pattern depends on the value in the invalid symbol indicator field. For example, if the field is set to 1 (as shown), then the selected pattern is applied; otherwise, if the bit is set to 0, then the selected pattern is not applied. On the other hand, if the DCI (e.g., DCI format 0_1 or format 0_2) is not configured to include the invalid symbol indicator field, then the selected pattern may be applied anyways.

Second, each of the at least two patterns may be respectively associated with a corresponding parameter that is configured and/or periodically transmitted by RRC signaling (not shown but similar to the UL DCI signaling of FIG. 11). For example, in the case when the PUSCH is a Type 1 CG (i.e., configured and periodically transmitted by RRC), the pattern associated with the same CORESET pool index value may be selected when the associated CORESETPoolIndex value is RRC configured for that CG configuration. Alternatively, an RRC parameter under each CG configuration may select or identify one of the at least two patterns, such as by identifying from {a first pattern, a second pattern, etc.} to signal the UE which of the at least two patterns to apply. When such RRC parameter is not configured, then none of the patterns may be selected or applied.

FIG. 12 is an example application of two invalid symbol patterns to a PUSCH repetition, in accordance with certain aspects of the present disclosure. In this example, both of two patterns may be selected and applied to the PUSCH transmission. Although the illustration provides an example of applying both patterns, the same method may be used for applying none or one of the two patterns. Similar to the options presented in FIG. 11 above, the determination of which pattern to be selected or applied may be based on signaling via a DCI or RRC.

First, when the PUSCH is dynamically scheduled (for DG) or activated (for Type 2 CG) by a DCI, the DCI may have an increased size to be configured to include two bits for the invalid symbol indicator field. The two-bit invalid symbol indicator field may then indicate whether each of the first or second patterns should be applied or not. That is, the two bits may indicate four different possibilities: “00” indicating applying neither patterns, “01” or “10” respectively indicating applying the first pattern or the second pattern, and “11” indicating applying both patterns.

Alternatively, as shown in FIG. 12, the DCI may maintain (or continue to use) a 1-bit size to indicate whether to apply the pattern associated with the other CORESET pool index value. For example, the pattern that is associated with the same CORESETPoolIndex value as the CORESETPoolIndex value of the CORESET in which the DCI is received is always applied. Whether the other pattern (associated with the other CORESETPoolIndex value) is applied or not is indicated by the 1-bit invalid symbol indicator field (e.g., “0” indicating not applying, and “1” indicating applying).

As shown in FIG. 12, the UE detects in a CORESET with CORESET pool index value being “1.” Because the first invalid symbol pattern is associated with the same CORESET in which the DCI is received, the UE applies the second invalid symbol pattern since the associated CORESET pool index value is “1.” The UE determines to apply the first pattern because the first pattern is associated with a CORESET pool index value of “0.” The UL DCI is configured to include the 1-bit invalid symbol indicator field, and is set to “1,” indicating the application of the first pattern (the pattern associated with the other CORESETPoolIndex value). Upon applying both patterns, the symbols indicated invalid in both patterns are removed from the PUSCH with repetition. Further, the nominal repetitions with only one symbol are omitted from the PUSCH transmission, as indicated in FIG. 12. In a different scenario, the UE applies only the first pattern if the invalid symbol indicator has a value of “0” instead of “1,” indicating not to apply the second pattern.

In the cases when the DCI is not configured to include the invalid symbol indicator field, the UE may determine based on default settings or behaviors. For example, the UE may be configured to apply both patterns by default. In another case, the UE may be configured to apply, by default, the pattern that is associated with the same CORESETPoolIndex value as the CORESET pool index value of the CORESET in which the DCI is received (similar to the case above in FIG. 11). In some cases, the UE may be configured to apply none of the patterns by default.

Second, when the PUSCH is a Type 1 CG (configured and periodically transmitted by RRC), the invalid symbol pattern(s) to be applied (one of them or both of them) may be RRC configured for that CG configuration (e.g., indicated by a corresponding parameter). For example, a parameter in RRC signaling under each CG configuration may select or indicate one of {the first pattern, the second pattern, none of the patterns} to have the UE to determine which of the patterns to apply accordingly. If such selection is not configured in the RRC signaling, then both of the patterns are to be applied by default. Different default behavior may be configured.

In another example, the parameter in RRC signaling under each CG configuration may select or indicate one of {the second pattern, both patterns, none of the patterns} for the UE. If such selection is not configured, then the first pattern is applied. In another example, the parameter in RRC signaling under each CG configuration may select or indicate one of {the first pattern, the second pattern, both patterns} for the UE. If such selection is not configured, then none of patterns is applied. Similar use of the RRC parameter may be applied when more than two patterns are provided to the UE.

The examples in both FIGS. 11 and 12 rely on the association of the first or second patterns with the first or second CORESETPoolIndex values, which are considered as corresponding parameters. In other scenarios, the corresponding parameters may use different values or associations. For example, the first or second invalid symbol patterns may be associated with a first or second transmission group in general. Such that each PUSCH is associated with first or second group, and hence, the respective selection of patterns based on the techniques above can be applied (e.g., in applying one, both, or none of the patterns). For example, the CORESETPoolIndex values (0 or 1) in the examples in FIGS. 11 and 12 may be replaced with a first or a second group.

Similarly, the corresponding parameters may include a first or a second SRS resource set to indicate which pattern to apply, as each PUSCH is also associated with a given SRS resource set as indicated in the scheduling/activating DCI or configured per CG configuration (for Type 1), or the SRS resource set may also be determined based on CORESETPoolIndex value. In other example, the CORESETPoolIndex values maybe replaced with a first or a second UE panel ID, or a first or a second UL beam group, among other parameter implementations.

### Example Wireless Communication Devices

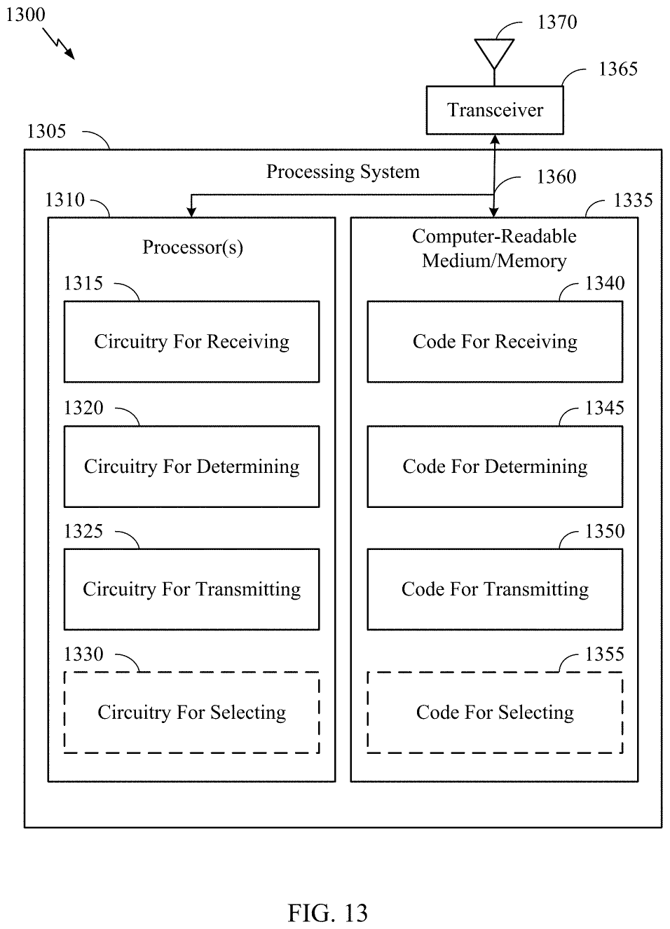

FIG. 13 illustrates a communications device 1300 that may include various components (e.g., corresponding to means-plus-function components) configured to perform operations for the techniques disclosed herein, such as the operations illustrated in FIG. 8. In some cases, the communications device 1300 may include the UE 104 illustrated in FIG. 1 and FIG. 2.

Communications device 1300 includes a processing system 1305 coupled to a transceiver 1365 (e.g., a transmitter and/or a receiver). Transceiver 1365 is configured to transmit and receive signals for the communications device 1300 via an antenna 1370, such as the various signals as described herein. Processing system 1305 may be configured to perform processing functions for communications device 1300, including processing signals received and/or to be transmitted by communications device 1300. The transceiver 1365 can include one or more components of UE 104 with reference to FIG. 2 such as, for example, transceiver 254, TX MIMO processor 266, transmit processor 264, receive processor 258, MIMO detector 256, and/or the like.

Processing system 1305 includes a processor 1310 coupled to a computer-readable medium/memory 1335 via a bus 1360. In certain aspects, computer-readable medium/memory 1335 is configured to store instructions (e.g., computer-executable code) that when executed by processor 1310, cause processor 1310 to perform the operations illustrated in FIG. 8, or other operations for performing the various techniques discussed herein for modifying a configured repetition pattern to avoid segmentation of nominal repetitions into multiple actual repetitions. In some cases, the processor 1310 can include one or more components of UE 104 with reference to FIG. 2 such as, for example, controller/processor 280 (including the symbol pattern configuration component 281), transmit processor 264, receive processor 258, and/or the like. Additionally, in some cases, the computer-readable medium/memory 1335 can include one or more components of UE 104 with reference to FIG. 2 such as, for example, memory 282 and/or the like.

In certain aspects, computer-readable medium/memory 1335 stores code 1340 for receiving, code 1345 for determining, code 1350 for transmitting, and code 1355 for selecting.

In some cases, the code 1340 for receiving may include code for receiving signaling configuring the UE with at least two patterns, each of the at least two patterns indicating one or more symbols considered invalid for PUSCH repetition transmission and code for receiving signaling scheduling the UE to transmit a first PUSCH with repetition and at least a second PUSCH.

In some cases, the code 1345 for determining may include code for determining which of the at least two patterns to apply when transmitting the first and second PUSCH and code for determining based on a value in an invalid symbol indicator field. The value may indicate any combination or none of the at least two patterns.

In some cases, code 1350 for transmitting may include code for transmitting the first PUSCH and second PUSCH in accordance with the determination.

In some cases, code 1355 for selecting may include code for selecting one of the at least two patterns based on a corresponding parameter associated with one of the first PUSCH with repetition dynamically scheduled or activated by the DCI or code for selecting one of the at least two patterns based on a corresponding parameter value associated with one of the first PUSCH with repetition of a Type 1 configured grant (CG).

In certain aspects, processor 1310 has circuitry configured to implement the code stored in the computer-readable medium/memory 1335. For example, processor 1310 includes circuitry 1315 for receiving, circuitry 1320 for determining, circuitry 1325 for transmitting, and circuitry 1330 for selecting.

In some cases, the circuitry 1315 for receiving may include circuitry for receiving signaling configuring the UE with at least two patterns, each of the at least two patterns indicating one or more symbols considered invalid for PUSCH repetition transmission and circuitry for receiving signaling scheduling the UE to transmit a first PUSCH with repetition and at least a second PUSCH.

In some cases, the circuitry 1320 for determining may include circuitry for determining which of the at least two patterns to apply when transmitting the first and second PUSCH and circuitry for determining based on a value in an invalid symbol indicator field. The value may indicate any combination or none of the at least two patterns.

In some cases, circuitry 1325 for transmitting may include circuitry for transmitting the first PUSCH and second PUSCH in accordance with the determination.

In some cases, circuitry 1330 for selecting may include circuitry for selecting one of the at least two patterns based on a corresponding parameter associated with one of the first PUSCH with repetition dynamically scheduled or activated by the DCI or circuitry for selecting one of the at least two patterns based on a corresponding parameter value associated with one of the first PUSCH with repetition of a Type 1 configured grant (CG).

In some examples, means for determining may include the controller/processor 280 and/or the symbol pattern configuration component 281 of the UE 104 illustrated in FIG. 2, and/or circuitry 1320 for determining of the communication device 1300 in FIG. 13.

In some examples, means for selecting may include the controller/processor 280 and/or the symbol pattern configuration component 281 of the UE 104 illustrated in FIG. 2, and/or circuitry 1330 for selecting of the communication device 1300 in FIG. 13.

In some examples, means for receiving or transmitting may include the transmitter unit 254 and/or antenna(s) 252 of the UE 104 illustrated in FIG. 2 and/or the transceiver 1365, circuitry 1315 for receiving or circuitry 1325 for transmitting of the communication device 1300 in FIG. 13.

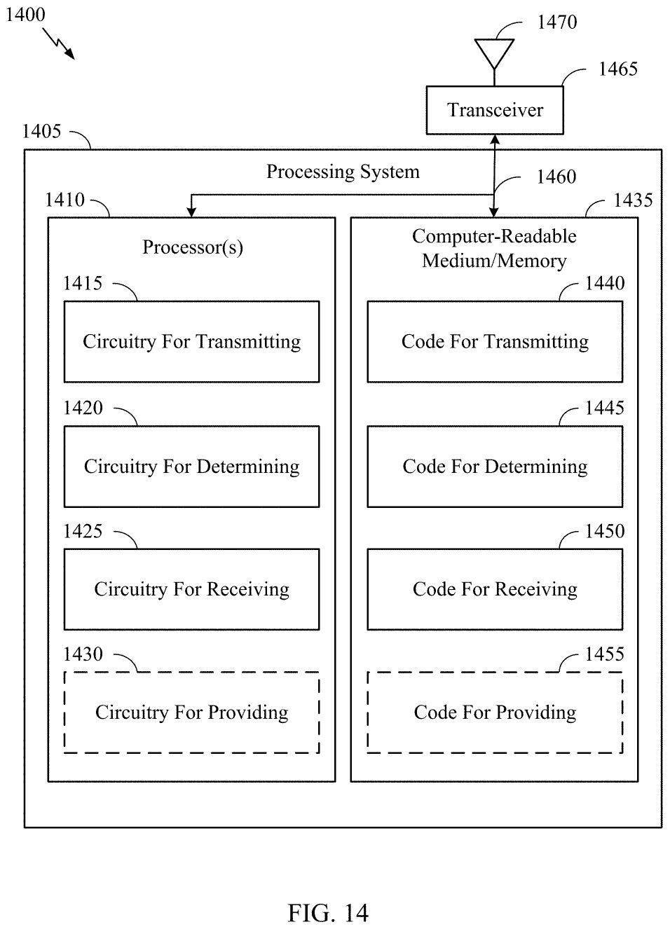

FIG. 14 illustrates a communications device 1400 that may include various components (e.g., corresponding to means-plus-function components) configured to perform operations for the techniques disclosed herein, such as the operations illustrated in FIG. 9. In some cases, the communications device 1400 may include the BS 102 illustrated in FIG. 1 and FIG. 2.

Communications device 1400 includes a processing system 1405 coupled to a transceiver 1465 (e.g., a transmitter and/or a receiver). Transceiver 1465 is configured to transmit and receive signals for the communications device 1400 via an antenna 1470, such as the various signals as described herein. Processing system 1405 may be configured to perform processing functions for communications device 1400, including processing signals received and/or to be transmitted by communications device 1400. The transceiver 1465 can include one or more components of BS 102 with reference to FIG. 2 such as, for example, transceiver 232, TX MIMO processor 230, transmit processor 220, receive processor 238, MIMO detector 236, and/or the like.

Processing system 1405 includes a processor 1410 coupled to a computer-readable medium/memory 1435 via a bus 1460. In certain aspects, computer-readable medium/memory 1435 is configured to store instructions (e.g., computer-executable code) that when executed by processor 1410, cause processor 1410 to perform the operations illustrated in FIG. 9, or other operations for performing the various techniques discussed herein for determining which patterns to apply in PUSCH with repetitions. In some cases, the processor 1410 can include one or more components of BS 102 with reference to FIG. 2 such as, for example, controller/processor 240 (including the symbol pattern configuration component 241), transmit processor 220, receive processor 238, and/or the like. Additionally, in some cases, the computer-readable medium/memory 1435 can include one or more components of BS 102 with reference to FIG. 2 such as, for example, memory 242 and/or the like.

In certain aspects, computer-readable medium/memory 1435 stores code 1440 for transmitting, code 1445 for determining, code 1450 for receiving, and code 1455 for providing.

In some cases, the code 1440 for transmitting may include code for transmitting signaling configuring a UE with at least two patterns, each of the at least two patterns indicating one or more symbols considered invalid for PUSCH repetition transmission and code for transmitting signaling scheduling the UE to transmit a first PUSCH with repetition and at least a second PUSCH.

In some cases, the code 1445 for determining may include code for determining which of the at least two patterns to apply when receiving the first and second PUSCH.

In some cases, the code 1450 for receiving may include code for receiving the first PUSCH and second PUSCH in accordance with the determination.

In some cases, the code 1455 for providing may include code for providing a value in an invalid symbol indicator field, such as in a DCI. The value may indicate any combination or none of the at least two patterns, and code for providing a corresponding parameter value associated with one of the first PUSCH with repetition of a Type 1 CG via RRC signaling.

In certain aspects, processor 1410 has circuitry configured to implement the code stored in the computer-readable medium/memory 1435. For example, processor 1410 includes circuitry 1415 for transmitting, circuitry 1420 for determining, circuitry 1425 for receiving, and circuitry 1430 for providing.

In some cases, the circuitry 1415 for transmitting may include circuitry for transmitting signaling configuring a UE with at least two patterns, each of the at least two patterns indicating one or more symbols considered invalid for PUSCH repetition transmission and circuitry for transmitting signaling scheduling the UE to transmit a first PUSCH with repetition and at least a second PUSCH.

In some cases, the circuitry 1420 for determining may include circuitry for determining which of the at least two patterns to apply when receiving the first and second PUSCH.

In some cases, the circuitry 1425 for receiving may include circuitry for receiving the first PUSCH and second PUSCH in accordance with the determination.

In some cases, the circuitry 1430 for providing may include circuitry for providing a value in an invalid symbol indicator field, such as in a DCI. The value may indicate any combination or none of the at least two patterns, and circuitry for providing a corresponding parameter value associated with one of the first PUSCH with repetition of a Type 1 CG via RRC signaling . . . .

In some examples, means for transmitting and receiving may include a transmitter or receiver, and/or an antenna(s) 234 and/or the controller/processor 240 of the BS 102 illustrated in FIG. 2 and/or the transceiver 1465, circuitry 1415 for transmitting, or circuitry 1425 for receiving of the communication device 1400 in FIG. 14.

In some examples, means for determining may include a controller or processor 240 of the BS 102 illustrated in FIG. 2 and/or circuitry 1420 for determining of the communication device 1400 in FIG. 14.

In some examples, means for providing may include a controller or processor 240 or the scheduler 244 of the BS 102 illustrated in FIG. 2 and/or circuitry 1430 for providing of the communication device 1400 in FIG. 14.

### Additional Wireless Communication Network Considerations

The techniques and methods described herein may be used for various wireless communications networks (or wireless wide area network (W WAN)) and radio access technologies (RATs). While aspects may be described herein using terminology commonly associated with 3G, 4G, and/or 5G (e.g., 5G new radio (NR)) wireless technologies, aspects of the present disclosure may likewise be applicable to other communication systems and standards not explicitly mentioned herein.

5G wireless communication networks may support various advanced wireless communication services, such as enhanced mobile broadband (eMBB), millimeter wave (mmW), machine type communications (MTC), and/or mission critical targeting ultra-reliable, low-latency communications (URLLC). These services, and others, may include latency and reliability requirements.

Returning to FIG. 1, various aspects of the present disclosure may be performed within the example wireless communication network 100.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells.

A macro cell may generally cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS.

Base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). Base stations 102 configured for 5G (e.g., 5G NR or Next Generation RAN (NG-RAN)) may interface with core network 190 through second backhaul links 184. Base stations 102 may communicate directly or indirectly (e.g., through the EPC 160 or core network 190) with each other over third backhaul links 134 (e.g., X2 interface). Third backhaul links 134 may generally be wired or wireless.

Small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. Small cell 102′, employing NR in an unlicensed frequency spectrum, may boost coverage to and/or increase capacity of the access network.

Some base stations, such as gNB 180 may operate in a traditional sub-6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station.

The communication links 120 between base stations 102 and, for example, UEs 104, may be through one or more carriers. For example, base stations 102 and UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Wireless communications system 100 further includes a Wi-Fi access point (AP) 150 in communication with Wi-Fi stations (STAs) 152 via communication links 154 in, for example, a 2.4 GHz and/or 5 GHz unlicensed frequency spectrum. When communicating in an unlicensed frequency spectrum, the STAs 152/AP 150 may perform a clear channel assessment (CCA) prior to communicating in order to determine whether the channel is available.

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, 4G (e.g., LTE), or 5G (e.g., NR), to name a few options.

EPC 160 may include a Mobility Management Entity (MME) 162, other MMES 164, a Serving Gateway 166, a Multimedia Broadcast Multicast Service (MBMS) Gateway 168, a Broadcast Multicast Service Center (BM-SC) 170, and a Packet Data Network (PDN) Gateway 172. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to the IP Services 176, which may include, for example, the Internet, an intranet, an IP Multimedia Subsystem (IMS), a PS Streaming Service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and may be used to schedule MBMS transmissions. MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

Core network 190 may include an Access and Mobility Management Function (AMF) 192, other AMFs 193, a Session Management Function (SMF) 194, and a User Plane Function (UPF) 195. AMF 192 may be in communication with a Unified Data Management (UDM) 196.

AMF 192 is generally the control node that processes the signaling between UEs 104 and core network 190. Generally, AMF 192 provides QoS flow and session management.

All user Internet protocol (IP) packets are transferred through UPF 195, which is connected to the IP Services 197, and which provides UE IP address allocation as well as other functions for core network 190. IP Services 197 may include, for example, the Internet, an intranet, an IP Multimedia Subsystem (IMS), a PS Streaming Service, and/or other IP services.

Returning to FIG. 2, various example components of BS 102 and UE 104 (e.g., the wireless communication network 100 of FIG. 1) are depicted, which may be used to implement aspects of the present disclosure.

At BS 102, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc.

A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

Processor 220 may process (e.g., encode and symbol map) the data and control information to obtain data symbols and control symbols, respectively. Transmit processor 220 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

At UE 104, antennas 252a-252r may receive the downlink signals from the BS 102 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM, etc.) to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 104 to a data sink 260, and provide decoded control information to a controller/processor 280.

On the uplink, at UE 104, transmit processor 264 may receive and process data (e.g., for the physical uplink shared channel (PUSCH)) from a data source 262 and control information (e.g., for the physical uplink control channel (PUCCH) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM, etc.), and transmitted to BS 102.

At BS 102, the uplink signals from UE 104 may be received by antennas 234a-t, processed by the demodulators in transceivers 232a-232t, detected by a MIMO detector 236 if applicable, and further processed by a receive processor 238 to obtain decoded data and control information sent by UE 104. Receive processor 238 may provide the decoded data to a data sink 239 and the decoded control information to the controller/processor 240.

Memories 242 and 282 may store data and program codes for BS 102 and UE 104, respectively.

Scheduler 244 may schedule UEs for data transmission on the downlink and/or uplink.

Antennas 252, processors 266, 258, 264, and/or controller/processor 280 of UE 104 and/or antennas 234, processors 220, 230, 238, and/or controller/processor 240 of BS 102 may be used to perform the various techniques and methods described herein.

For example, as shown in FIG. 2, the controller/processor 240 of the BS 102 has symbol pattern configuration component 241 that may be configured to perform the operations shown in FIG. 9, as well as other operations described herein for determining which patterns to apply in PUSCH with repetitions. As shown in FIG. 2, the controller/processor 280 of the UE 104 has a symbol pattern configuration component 281 that may be configured to perform the operations shown in FIG. 8, as well as other operations described herein for determining which patterns to apply in PUSCH with repetitions. Although shown at the controller/processor, other components of UE 104 and BS 102 may be used to perform the operations described herein.

5G may utilize orthogonal frequency division multiplexing (OFDM) with a cyclic prefix (CP) on the uplink and downlink. 5G may also support half-duplex operation using time division duplexing (TDD). OFDM and single-carrier frequency division multiplexing (SC-FDM) partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers in some examples. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, etc.).

As above, FIGS. 3A-3D depict various example aspects of data structures for a wireless communication network, such as wireless communication network 100 of FIG. 1.

In various aspects, the 5G frame structure may be frequency division duplex (FDD), in which for a particular set of subcarriers (carrier system bandwidth), subframes within the set of subcarriers are dedicated for either DL or UL. 5G frame structures may also be time division duplex (TDD), in which for a particular set of subcarriers (carrier system bandwidth), subframes within the set of subcarriers are dedicated for both DL and UL. In the examples provided by FIGS. 3A and 3C, the 5G frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description below applies also to a 5G frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. In some examples, each slot may include 7 or 14 symbols, depending on the slot configuration.

For example, for slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission).

The number of slots within a subframe is based on the slot configuration and the numerology. For slot configuration 0, different numerologies 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 3A-3D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for a UE (e.g., UE 104 of FIGS. 1 and 2). The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., 104 of FIGS. 1 and 2) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Technical Additional Considerations

The preceding description provides examples of determining which of at least two invalid symbol patterns to apply to PUSCH transmission with repetitions. Changes may be made in the function and arrangement of elements discussed without departing from the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the disclosure is intended to cover such an apparatus or method, which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

The techniques described herein may be used for various wireless communication technologies, such as 5G (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

The methods disclosed herein comprise one or more steps or actions for achieving the methods. The method steps and/or actions may be interchanged with one another. In other words, unless a specific order of steps or actions is specified, the order and/or use of specific steps and/or actions may be modified.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

Reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, a digital signal processor (DSP), an application specific integrated circuit (ASIC), or a processor (e.g., a general purpose or specifically programmed processor).

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user equipment (see FIG. 1), a user interface (e.g., keypad, display, mouse, joystick, touchscreen, biometric sensor, proximity sensor, light emitting element, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above can also be considered as examples of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIGS. 8 and 9, as well as other operations described herein for determining which patterns to apply in PUSCH with repetitions.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated herein. Various modifications, changes and variations may be made in the arrangement, operation, and details of the methods and apparatus described herein.

### Example Aspects

Implementation examples are described in the following numbered aspects:

Aspect 1: A method for wireless communications by a user equipment (UE), comprising: receiving signaling configuring the UE with at least two patterns, each of the at least two patterns indicating one or more symbols considered invalid for physical uplink shared channel (PUSCH) repetition transmission; receiving signaling scheduling the UE to transmit a first PUSCH with repetition and at least a second PUSCH; determining which of the at least two patterns to apply when transmitting the first and second PUSCH; and transmitting the first PUSCH and second PUSCH in accordance with the determination.

Aspect 2: The method of Aspect 1, wherein the first PUSCH with repetition and the second PUSCH are in common component carriers (CCs) or bandwidth parts (BWPs).

Aspect 3: The method of Aspect 1, wherein the at least second PUSCH at least partially overlaps in time with the first PUSCH with repetition.

Aspect 4: The method of Aspect 1, wherein the first PUSCH with repetition is scheduled by a downlink control information (DCI), and wherein the at least two patterns are associated with corresponding parameters for the first PUSCH with repetition and the second PUSCH.

Aspect 5: The method of Aspect 4, wherein the corresponding parameters comprises at least one of: control resource set (CORESET) pool index values for CORESET configuration; indication of a transmission group; a sounding reference signal (SRS) resource set; identification of UE panel; or indication of a UE beam group.

Aspect 6: The method of Aspect 4, wherein determining which of the at least two patterns to apply comprises: selecting one of the at least two patterns based on a corresponding parameter associated with one of the first PUSCH with repetition dynamically scheduled or activated by the DCI.

Aspect 7: The method of Aspect 6, wherein the DCI includes an invalid symbol indicator field indicating whether to apply the selected one of the at least two patterns based on the corresponding parameter associated with one of the first PUSCH with repetition.

Aspect 8: The method of Aspect 6, further comprising determining to apply the one of the at least two patterns when the DCI does not include an invalid symbol indicator field.

Aspect 9: The method of Aspect 4, wherein determining which of the at least two patterns to apply comprises: determining based on a value in an invalid symbol indicator field in the DCI, wherein the value indicates any combination or none of the at least two patterns.

Aspect 10: The method of Aspect 9, wherein, when the at least two patterns comprise two patterns, the value includes a two bit value for indicating: none of the at least two patterns to be applied; a first of the two patterns to be applied; a second of the two patterns to be applied; or both of the two patterns to be applied.

Aspect 11: The method of Aspect 9, wherein, when the at least two patterns comprises two patterns, determining which of the at least two patterns to apply comprises: always applying a first one of the two patterns associated with a first one of the corresponding parameters corresponding to the DCI; and wherein the value includes a one bit value for indicating: whether to apply, based on the one bit value, a second one of the at least two patterns associated with a second one of the corresponding parameters not corresponding to the DCI.

Aspect 12: The method of Aspect 4, wherein determining which of the at least two patterns to apply comprises: determining to apply all or none of the at least two patterns when the DCI does not provide a relevant indication.

Aspect 13: The method of Aspect 1, wherein receiving signaling configuring the UE with at least two patterns comprises: receiving the at least two patterns via radio resource control (RRC) signaling.

Aspect 14: The method of Aspect 1, wherein determining which of the at least two patterns to apply comprises: selecting one of the at least two patterns based on a corresponding parameter value associated with one of the first PUSCH with repetition of a Type 1 configured grant (CG).

Aspect 15: The method of Aspect 14, wherein the one of the at least two patterns is associated with the corresponding parameter value configured for the one of the first PUSCH with repetition via radio resource control (RRC) signaling.

Aspect 16: The method of Aspect 15, wherein the RRC signaling comprises a parameter that, when configured for each CG configuration, explicitly indicates a selection of the at least two patterns; or when not configured for each CG configuration, implicitly indicates a remainder of the at least two patterns.

Aspect 17: The method of Aspect 15, wherein the RRC signaling configures the first PUSCH with repetition, and includes a pattern identification parameter, for each CG configuration, identifying one of the at least two patterns.

Aspect 18: The method of Aspect 17, determining which of the at least two patterns to apply comprises: determining to apply none of the at least two patterns when the pattern identification parameter does not identify any of the at least two patterns.

Aspect 19: A method for wireless communications by at least two network entities, comprising: transmitting signaling configuring a user equipment (UE) with at least two patterns, each of the at least two patterns indicating one or more symbols considered invalid for physical uplink shared channel (PUSCH) repetition transmission; transmitting signaling scheduling the UE to transmit a first PUSCH with repetition and at least a second PUSCH; determining which of the at least two patterns to apply when receiving the first and second PUSCH; and receiving the first PUSCH and second PUSCH in accordance with the determination.

Aspect 20: The method of Aspect 19, wherein the first PUSCH with repetition is scheduled by a downlink control information (DCI), and wherein the at least two patterns are associated with corresponding parameters for the first PUSCH with repetition and the second PUSCH.

Aspect 21: The method of Aspect 20, wherein the corresponding parameters comprises at least one of: control resource set (CORESET) pool index values for CORESET configuration; indication of a transmission group; a sounding reference signal (SRS) resource set; identification of UE panel; or indication of a UE beam group.

Aspect 22: The method of Aspect 20, wherein determining which of the at least two patterns to apply comprises: indicating one of the at least two patterns using a corresponding parameter associated with one of the first PUSCH with repetition dynamically scheduled or activated by the DCI.

Aspect 23: The method of Aspect 20, wherein determining which of the at least two patterns to apply comprises: providing a value in an invalid symbol indicator field in the DCI, wherein the value indicates any combination or none of the at least two patterns.

Aspect 24: The method of Aspect 19, wherein determining which of the at least two patterns to apply comprises: providing a corresponding parameter value associated with one of the first PUSCH with repetition of a Type 1 configured grant (CG) via radio resource control (RRC) signaling.

Aspect 25: The method of Aspect 24, further comprising associating the corresponding parameter value with the one of the at least two patterns for the one of the first PUSCH with repetition.

Aspect 26: The method of Aspect 25, wherein the RRC signaling comprises a parameter that, when configured for each CG configuration, explicitly indicates a selection of the at least two patterns; or when not configured for each CG configuration, implicitly indicates a remainder of the at least two patterns.

Aspect 27: The method of Aspect 24, wherein the RRC signaling configures the first PUSCH with repetition, and includes a pattern identification parameter, for each CG configuration, identifying one of the at least two patterns.

Aspect 28: The method of Aspect 27, determining which of the at least two patterns to apply comprises: determining to apply none of the at least two patterns when the pattern identification parameter does not identify any of the at least two patterns.

Aspect 29: An apparatus, comprising: a memory comprising computer-executable instructions and one or more processors configured to execute the computer-executable instructions and cause the one or more processors to perform a method in accordance with any one of Aspects 1-28.

Aspect 30: An apparatus, comprising means for performing a method in accordance with any one of Aspects 1-28.

Aspect 31: A non-transitory computer-readable medium comprising computer-executable instructions that, when executed by one or more processors, cause the one or more processors to perform a method in accordance with any one of Aspects 1-28.

Aspect 32: A computer program product embodied on a computer-readable storage medium comprising code for performing a method in accordance with any one of Aspects 1-28.

1. A method for wireless communications by a user equipment (UE), comprising:
receiving signaling configuring the UE with at least two patterns, each of the at least two patterns indicating one or more symbols considered invalid for physical uplink shared channel (PUSCH) repetition transmission;
receiving signaling scheduling the UE to transmit a first PUSCH with repetition and at least a second PUSCH;
determining which of the at least two patterns to apply when transmitting the first and second PUSCH; and
transmitting the first PUSCH and second PUSCH in accordance with the determination.

2. The method of claim 1, wherein the first PUSCH with repetition and the second PUSCH are in common component carriers (CCs) or bandwidth parts (BWPs).

3. The method of claim 1, wherein the second PUSCH at least partially overlaps in time with the first PUSCH with repetition.

4. The method of claim 1, wherein the first PUSCH with repetition is scheduled by a downlink control information (DCI), and wherein the at least two patterns are associated with corresponding parameters for the first PUSCH with repetition and the second PUSCH.

5. The method of claim 4, wherein the corresponding parameters comprises at least one of:
control resource set (CORESET) pool index values for CORESET configuration;
indication of a transmission group;
a sounding reference signal (SRS) resource set;
identification of UE panel; or
indication of a UE beam group.

6. The method of claim 4, wherein determining which of the at least two patterns to apply comprises:
selecting one of the at least two patterns based on a corresponding parameter associated with one of the first PUSCH with repetition dynamically scheduled or activated by the DCI.

7. The method of claim 6, wherein the DCI includes an invalid symbol indicator field indicating whether to apply the selected one of the at least two patterns based on the corresponding parameter associated with one of the first PUSCH with repetition.

8. The method of claim 6, further comprising determining to apply the one of the at least two patterns when the DCI does not include an invalid symbol indicator field.

9. The method of claim 4, wherein determining which of the at least two patterns to apply comprises:
determining based on a value in an invalid symbol indicator field in the DCI, wherein the value indicates any combination or none of the at least two patterns.

10. The method of claim 9, wherein, when the at least two patterns comprise two patterns, the value includes a two bit value for indicating:
none of the at least two patterns to be applied;
a first of the two patterns to be applied;
a second of the two patterns to be applied; or
both of the two patterns to be applied.

11. The method of claim 9, wherein, when the at least two patterns comprises two patterns, determining which of the at least two patterns to apply comprises:
always applying a first one of the two patterns associated with a first one of the corresponding parameters corresponding to the DCI; and
wherein the value includes a one bit value for indicating: whether to apply, based on the one bit value, a second one of the at least two patterns associated with a second one of the corresponding parameters not corresponding to the DCI.

12. The method of claim 4, wherein determining which of the at least two patterns to apply comprises:
determining to apply all or none of the at least two patterns when the DCI does not provide a relevant indication.

13. The method of claim 1, wherein receiving signaling configuring the UE with at least two patterns comprises:
receiving the at least two patterns via radio resource control (RRC) signaling.

14. The method of claim 1, wherein determining which of the at least two patterns to apply comprises:
selecting one of the at least two patterns based on a corresponding parameter value associated with one of the first PUSCH with repetition of a Type 1 configured grant (CG).

15. The method of claim 14, wherein the one of the at least two patterns is associated with the corresponding parameter value configured for the one of the first PUSCH with repetition via radio resource control (RRC) signaling.

16. The method of claim 15, wherein the RRC signaling comprises a parameter that,
when configured for each CG configuration, explicitly indicates a selection of the at least two patterns; or
when not configured for each CG configuration, implicitly indicates a remainder of the at least two patterns.

17. The method of claim 15, wherein the RRC signaling configures the first PUSCH with repetition, and includes a pattern identification parameter, for each CG configuration, identifying one of the at least two patterns.

18. The method of claim 17, determining which of the at least two patterns to apply comprises:
determining to apply none of the at least two patterns when the pattern identification parameter does not identify any of the at least two patterns.

19. An apparatus for wireless communications performed by a user equipment (UE), comprising:
a memory; and
a processor coupled to the memory, the processor and the memory configured to:
receive signaling configuring the UE with at least two patterns, each of the at least two patterns indicating one or more symbols considered invalid for physical uplink shared channel (PUSCH) repetition transmission;
receive signaling scheduling the UE to transmit a first PUSCH with repetition and at least a second PUSCH;
determine which of the at least two patterns to apply when transmitting the first and second PUSCH; and
transmit the first PUSCH and second PUSCH in accordance with the determination.

20. The apparatus of claim 19, wherein the first PUSCH with repetition and the second PUSCH are in common component carriers (CCs) or bandwidth parts (BWPs).

21. The apparatus of claim 19, wherein the second PUSCH at least partially overlaps in time with the first PUSCH with repetition.

22. The apparatus of claim 19, wherein the first PUSCH with repetition is scheduled by a downlink control information (DCI), and wherein the at least two patterns are associated with corresponding parameters for the first PUSCH with repetition and the second PUSCH.

23. The apparatus of claim 22, wherein the corresponding parameters comprises at least one of:
control resource set (CORESET) pool index values for CORESET configuration;
indication of a transmission group;
a sounding reference signal (SRS) resource set;
identification of UE panel; or
indication of a UE beam group.

24. The apparatus of claim 22, wherein the processor and the memory are further configured to determine which of the at least two patterns to apply by:
selecting one of the at least two patterns based on a corresponding parameter associated with one of the first PUSCH with repetition dynamically scheduled or activated by the DCI.

25. The apparatus of claim 22, wherein the processor and the memory are further configured to determine which of the at least two patterns to apply by:
determining based on a value in an invalid symbol indicator field in the DCI, wherein the value indicates any combination or none of the at least two patterns.

26. The apparatus of claim 22, wherein the processor and the memory are further configured to determine which of the at least two patterns to apply by:
determining to apply all or none of the at least two patterns when the DCI does not provide a relevant indication.

27. The apparatus of claim 19, wherein the processor and the memory are further configured to receive signaling configuring the UE with at least two patterns by:
receiving the at least two patterns via radio resource control (RRC) signaling.

28. The apparatus of claim 19, wherein the processor and the memory are further configured to determine which of the at least two patterns to apply by:
selecting one of the at least two patterns based on a corresponding parameter value associated with one of the first PUSCH with repetition of a Type 1 configured grant (CG).

29. An apparatus for wireless communications performed by a user equipment (UE), comprising:
means for receiving signaling configuring the UE with at least two patterns, each of the at least two patterns indicating one or more symbols considered invalid for physical uplink shared channel (PUSCH) repetition transmission;
means for receiving signaling scheduling the UE to transmit a first PUSCH with repetition and at least a second PUSCH;
means for determining which of the at least two patterns to apply when transmitting the first and second PUSCH; and
means for transmitting the first PUSCH and second PUSCH in accordance with the determination.

30. A non-transitory computer readable medium having instructions stored thereon for:
receiving signaling configuring a user equipment (UE) with at least two patterns, each of the at least two patterns indicating one or more symbols considered invalid for physical uplink shared channel (PUSCH) repetition transmission;
receiving signaling scheduling the UE to transmit a first PUSCH with repetition and at least a second PUSCH;
determining which of the at least two patterns to apply when transmitting the first and second PUSCH; and
transmitting the first PUSCH and second PUSCH in accordance with the determination.
